(19) United States
(12) Patent Application Publication
(10) Pub. No.: US 2024/0378435 A1
(43) Pub. Date: Nov. 14, 2024

(54) TRAINING DATA SAMPLING DEVICE AND A METHOD THEREOF

(71) Applicants: HYUNDAI MOTOR COMPANY, Seoul (KR); KIA CORPORATION, Seoul (KR)

(72) Inventors: Sei Jun Chung, Seoul (KR); Byeong Wook Jeon, Seoul (KR)

(73) Assignees: HYUNDAI MOTOR COMPANY, Seoul (KR); KIA CORPORATION, Seoul (KR)

(21) Appl. No.: 18/367,659

(22) Filed: Sep. 13, 2023

(30) Foreign Application Priority Data
May 11, 2023 (KR) 10-2023-0061195

(51) Int. Cl. G06N 3/08

(52) U.S. Cl. CPC G06N 3/08

(57) ABSTRACT

A training data sampling device and a training data sampling method may improve the reliability of training data by estimating at least one label interval for time-series data, detecting a temporal feature from the time-series data, and sampling the training data including the temporal feature for the respective label interval. To the end, the training data sampling device may include an input device that receives time-series data and may include a controller that estimates at least one label interval from the time-series data, detects a temporal feature from the time-series data, and samples training data including the temporal feature by the label interval.

### CROSS-REFERENCE TO RELATED APPLICATION

This application claims the benefit of and priority to Korean Patent Application No. 10-2023-0061195, filed in the Korean Intellectual Property Office on May 11, 2023, the entire contents of which are incorporated herein by reference.

### TECHNICAL FIELD

The present disclosure relates to a technology for sampling training data from time-series data.

### BACKGROUND

In general, an artificial neural network (ANN) is an algorithm that simulates a human neural structure to allow a machine to perform training, as a field of artificial intelligence (AI). The ANN has been recently applied to image recognition, voice recognition, and natural language processing to show excellent effects. The ANN consists of an input layer for receiving an input, a hidden layer for actually performing training, and an output layer for returning the result of an operation. A neural network having a plurality of hidden layers is referred to as a “deep neural network (DNN)”, and is also a type of ANN.

The ANN allows a computer to perform training by itself based on data. An appropriate ANN model and data to be analyzed are needed to solve a problem by using ANN. The ANN model for solving a problem is trained based on data. Before training the model, it is necessary to process data appropriately. The reason is that input data and output data required by the ANN model are regularized. Accordingly, it is necessary to preprocess the obtained raw data to suit the required input data. The preprocessed data needs to be divided into two types. In other words, the data needs to be divided into a train dataset and a validation dataset. The train dataset is used to train the model, and the validation dataset is used to verify the performance of the model.

There are several reasons for validating the ANN model. ANN developers tune a model by modifying a hyperparameter of the model based on the validation result of the model. Moreover, the model is verified to select a suitable model among various models. The reason that model verification is necessary is as follows.

The first reason is to predict accuracy. The purpose of ANN is to achieve good performance for non-sample data that is not used for training as a result. Accordingly, after building a model, it is essential to determine how well the model will operate with respect to non-sample data. However, because a model is not validated by using the train dataset, the accuracy of the model needs to be measured by using a validation dataset separate from the train dataset.

The second reason is to improve the performance of a model by tuning the model. For example, overfitting may be prevented. The overfitting means that the model is excessively trained on the train dataset. For example, when the training accuracy is high but the validation accuracy is low, the overfitting may be suspected. Moreover, this may be identified in more detail through training loss and validation loss. When the overfitting has occurred, it is necessary to increase the validation accuracy by preventing the overfitting. Methods such as regularization or dropout may be used to prevent overfitting.

In the meantime, to sample training data from time-series data, a sliding window method is mainly used to sample training data while a fixed window size having a fixed stride is slid on time-series data.

Because the sliding window method samples the training data without a preprocessing process of identifying a point in time when a temporal feature occurs in time-series data, the sliding window method samples even unnecessary training data that does not include the temporal feature. Here, the temporal feature refers to an abrupt change (e.g., the occurrence and termination of an event) in time-series data.

Furthermore, because a user arbitrarily determines the size and stride of a window, which has a great influence on sampling training data including a temporal feature, the sliding window method may completely omit the temporal feature from the time-series data.

Besides, the sliding window method may not detect a temporal feature in monotonic time-series data with high accuracy, and the segmentation accuracy in time-series data with rapidly changing a label may be reduced. In particular, the explanation possibility of AI may be reduced.

The matters described in this background are intended to enhance the understanding of the background of the present disclosure and may include matters that are not the prior art already known to those of ordinary skill in the art.

### SUMMARY

The present disclosure has been made to solve the above-mentioned problems occurring in the prior art while advantages achieved by the prior art are maintained intact.

In an embodiment, a training data sampling device and a training data sampling method may improve the reliability of training data by estimating at least one label interval for time-series data, detecting a temporal feature from the time-series data, and sampling the training data including the temporal feature for the respective label interval.

In another embodiment, a training data sampling device and a training data sampling method may estimate at least one label from the time-series data and may determine an interval corresponding to each label, by performing stepwise segmentation on time-series data based on a semantic segmentation technique (or model).

In another embodiment, a training data sampling device and a training data sampling method may sample training data including a temporal feature from time-series data by detecting the temporal feature indicating the occurrence or termination of an event with respect to the time-series data based on a change point detection (CPD) algorithm (or model).

In another embodiment, a training data sampling device and method that may sample training data to include at least one temporal feature by detecting a temporal feature indicating the occurrence or termination of an event from time-series data based on a CPD algorithm (or model) and by determining a window size (or sampling size) based on a maximum separation distance between change points (CPs) adjacent to each other among CPs corresponding to the temporal feature.

Objects of the present disclosure are not limited to the above-mentioned object. Other objects and advantages of the present disclosure that is not mentioned should be understood from the following description, and it should be apparently understood from an embodiment of the present disclosure. In addition, it should be easily understood that the objects and advantages of the disclosure are realized by means and combinations described in the appended claims.

The technical problems to be solved by the present disclosure are not limited to the aforementioned problems. Any other technical problems not mentioned herein should be clearly understood from the following description by those having ordinary skill in the art to which the present disclosure pertains.

In an embodiment, a training data sampling device may include an input device that receives time-series data. The training data sampling device may also include a controller that estimates at least one label interval from the time-series data, detects a temporal feature from the time-series data, and samples training data including the temporal feature by the label interval.

In an embodiment of the present disclosure, the controller may determine at least one label interval in the time-series data by performing stepwise segmentation on the time-series data.

In an embodiment of the present disclosure, the controller may detect a temporal feature indicating an occurrence or termination of an event with respect to the time-series data and may sample training data including the temporal feature from the time-series data.

In an embodiment of the present disclosure, the controller may detect the temporal feature based on a change point detection (CPD) algorithm.

In an embodiment of the present disclosure, the controller may determine a sampling size based on a maximum separation distance between change points (CPs), which are adjacent to each other, from among CPs corresponding to the temporal feature.

In an embodiment of the present disclosure, the controller may sample first training data, second training data, and third training data in a first label interval of the time-series data. The controller may also sample first training data, second training data, third training data, and fourth training data in a second label interval of the time-series data. The controller may also sample first training data, second training data, third training data, and fourth training data in a third label interval of the time-series data. The controller may also sample first training data and second training data in a fourth label interval of the time-series data.

In an embodiment of the present disclosure, the controller may generate a train dataset by using the first training data, the second training data, and the third training data in the first label interval, by using the first training data, the second training data, the third training data, and the fourth training data in the second label interval, by using the first training data, the second training data, the third training data, and the fourth training data in the third label interval, and by using the first training data and the second training data in the fourth label interval.

In an embodiment of the present disclosure, the time-series data is streaming time-series data.

In an embodiment of the present disclosure, the time-series data is multivariate time-series data.

According to an aspect of the present disclosure, a training data sampling method may include receiving, by an input device, time-series data. The method may also include estimating, by a controller, at least one label interval from the time-series data. The method may also include detecting, by the controller, a temporal feature from the time-series data. The method may also include sampling, by the controller, training data including the temporal feature by the label interval.

In an embodiment of the present disclosure, the estimating of the at least one label interval from the time-series data may include determining, by the controller, at least one label interval in the time-series data by performing stepwise segmentation on the time-series data.

In an embodiment of the present disclosure, the detecting of the temporal feature from the time-series data may include detecting, by the controller, a temporal feature indicating an occurrence or termination of an event with respect to the time-series data.

In an embodiment of the present disclosure, the detecting of the temporal feature from the time-series data may include detecting, by the controller, the temporal feature from the time-series data based on a change point detection (CPD) algorithm.

In an embodiment of the present disclosure, the sampling of the training data including the temporal feature by the label interval may include determining, by the controller, a sampling size based on a maximum separation distance between CPs, which are adjacent to each other, from among CPs corresponding to the temporal feature.

In an embodiment of the present disclosure, the sampling of the training data including the temporal feature by the label interval may include sampling, by the controller, first training data, second training data, and third training data in a first label interval of the time-series data. The sampling of the training data including the temporal feature by the label interval may also include sampling, by the controller, first training data, second training data, third training data, and fourth training data in a second label interval of the time-series data. The sampling of the training data including the temporal feature by the label interval may also include sampling, by the controller, first training data, second training data, third training data, and fourth training data in a third label interval of the time-series data. The sampling of the training data including the temporal feature by the label interval may also include sampling, by the controller, first training data and second training data in a fourth label interval of the time-series data.

In an embodiment of the present disclosure, the sampling of the training data including the temporal feature by the label interval may further include generating, by the controller, a train dataset by using the first training data, the second training data, and the third training data in the first label interval, by using the first training data, the second training data, the third training data, and the fourth training data in the second label interval, by using the first training data, the second training data, the third training data, and the fourth training data in the third label interval, and by using the first training data and the second training data in the fourth label interval.

### BRIEF DESCRIPTION OF THE DRAWINGS

The above and other objects, features, and advantages of the present disclosure should be more apparent from the following detailed description taken in conjunction with the accompanying drawings:

FIG. 1 is a configuration diagram of a training data sampling device, according to an embodiment of the present disclosure;

FIG. 2 is a diagram illustrating a temporal feature detected from multivariate time-series data by a controller provided in a training data sampling device, according to an embodiment of the present disclosure;

FIG. 3 is a diagram illustrating a process in which a controller provided in a training data sampling device performs stepwise segmentation on time-series data, according to an embodiment of the present disclosure;

FIG. 4 is a diagram illustrating a process in which a controller provided in a training data sampling device detects training data including a temporal feature from multivariate time-series data, according to an embodiment of the present disclosure;

FIG. 5 is a flowchart of a training data sampling method, according to an embodiment of the present disclosure; and

FIG. 6 is a block diagram showing a computing system for executing a training data sampling method, according to an embodiment of the present disclosure.

### DETAILED DESCRIPTION

Hereinafter, some embodiments of the present disclosure should be described in detail with reference to the accompanying drawings. In adding reference numerals to components of each drawing, it should be noted that the same components have the same reference numerals, although they are indicated on another drawing. Furthermore, in describing the embodiments of the present disclosure, detailed descriptions associated with well-known functions or configurations have been omitted when they may make subject matters of the present disclosure unnecessarily obscure.

In describing elements of an embodiment of the present disclosure, the terms first, second, A, B, (a), (b), and the like may be used herein. These terms are only used to distinguish one element from another element, but do not limit the corresponding elements irrespective of the nature, order, or priority of the corresponding elements. Furthermore, unless otherwise defined, all terms including technical and scientific terms used herein are to be interpreted as is customary in the art to which the present disclosure belongs. It should be understood that terms used herein should be interpreted as having a meaning that is consistent with their meaning in the context of the present disclosure and the relevant art and should not be interpreted in an idealized or overly formal sense unless expressly so defined herein. When a component, device, element, or the like of the present disclosure is described as having a purpose or performing an operation, function, or the like, the component, device, element, or the like should be considered herein as being “configured to” meet that purpose or to perform that operation or function. Each of the component, device, element, and the like may separately embody or be included with a processor and a memory, such as a non-transitory computer readable media, as part of the apparatus.

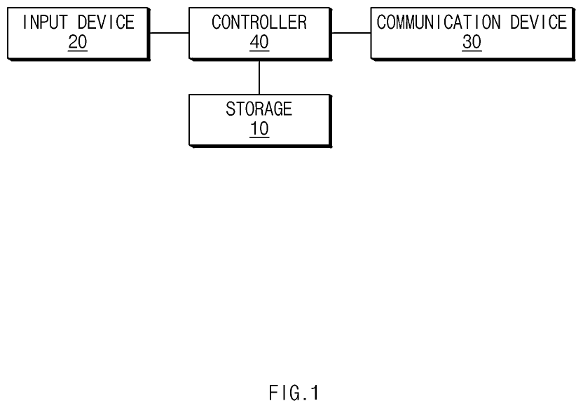

FIG. 1 is a configuration diagram of a training data sampling device, according to an embodiment of the present disclosure.

As shown in FIG. 1, a training data sampling device according to an embodiment of the present disclosure may include storage 10, an input device 20, a communication device 30, and a controller 40. At this time, in accordance with a method of operating a training data sampling device according to an embodiment of the present disclosure, each of the components may be implemented as one device after being coupled with one another, or a part of the components may be omitted.

Referring to each of the components, first of all, the storage 10 may store various logics, algorithms, and programs, which are required in a process of estimating at least one label interval for time-series data, detecting a temporal feature from the time-series data, and sampling training data including the temporal feature for each label interval.

The storage 10 may store a semantic segmentation technique (or model) that has been trained and a change point detection (CPD) algorithm (or model) that has been trained.

The storage 10 may store a train dataset, which is a set of training data sampled by the controller 40.

The storage 10 may include at least one type of a storage medium among a flash memory type of a memory, a hard disk type of a memory, a micro type of a memory, a card type (e.g., a Secure Digital (SD) card or an eXtream Digital (XD) card) of a memory, a random access memory (RAM) type of a memory, a static RAM (SRAM) type of a memory, a read-only memory (ROM) type of a memory, a programmable ROM (PROM) type of a memory, an electrically erasable PROM (EEPROM) type of a memory, a magnetic RAM (MRAM) type of a memory, a magnetic disk type of a memory, an optical disc type of a memory, or the like.

The input device 20 may receive time-series data. Here, the time-series data is, for example, streaming time-series data and may include audio, video, animation, and the like. Furthermore, the time-series data may include multivariate time-series data.

The communication device 30 may be a module that provides a communication interface with a deep learning server (not shown) and may include at least one of a mobile communication module, a wireless Internet module, or a short-range communication module.

The mobile communication module may transmit a train dataset to the deep learning server through a mobile communication network built according to technical standards or communication methods (e.g., global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), long term evolution (LTE), long term evolution-advanced (LTE-A), and the like) for mobile communication.

The wireless Internet module may be a module for wireless Internet access, and may transmit a train dataset to the deep learning server through wireless LAN (WLAN), Wireless-Fidelity (Wi-Fi), Wi-Fi Direct, digital living network alliance (DLNA), wireless broadband (WiBro), world interoperability for microwave access (WiMAX), high speed downlink packet access (HSDPA), high speed uplink packet access (HSUPA), long term evolution (LTE), long term evolution-advanced (LTE-A), and the like.

The short-range communication module may transmit the train dataset to the deep learning server using at least one of technologies such as Bluetooth™, radio frequency identification (RFID), infrared data association (IrDA), ultra wideband (UWB), ZigBee, near field communication (NFC), or wireless universal serial bus (Wireless USB).

The controller 40 may perform overall control such that each of the components is capable of normally performing functions of the components. The controller 40 may be implemented in the form of hardware, may be implemented in the form of software, or may be implemented in the form of the combination of hardware and software. In an embodiment, the controller 40 may be implemented as a microprocessor but is not limited thereto.

The controller 40 may perform various controls in a process of estimating at least one label interval from the time-series data, detecting a temporal feature from the time-series data, and sampling training data including the temporal feature by the label interval.

The controller 40 may estimate at least one label from the time-series data and may determine an interval corresponding to each label, by performing stepwise segmentation on time-series data, which is received through the input device 20, based on a semantic segmentation technique (or model) stored in the storage 10.

The controller 40 may detect the temporal feature indicating the occurrence or termination of an event with respect to the time-series data, which is received through the input device 20, based on a CPD algorithm (or model) stored in the storage 10. The controller 40 may also sample training data including a temporal feature from time-series data.

The controller 40 may detect a temporal feature indicating the occurrence or termination of an event from time-series data, which is received through the input device 20, based on a CPD algorithm (or model) stored in the storage 10. The controller 40 may also determine a window size (or sampling size) based on a maximum separation distance between change points (CPs) adjacent to each other among CPs corresponding to the temporal feature. The controller 40 may also sample training data to include at least one temporal feature based on a window size.

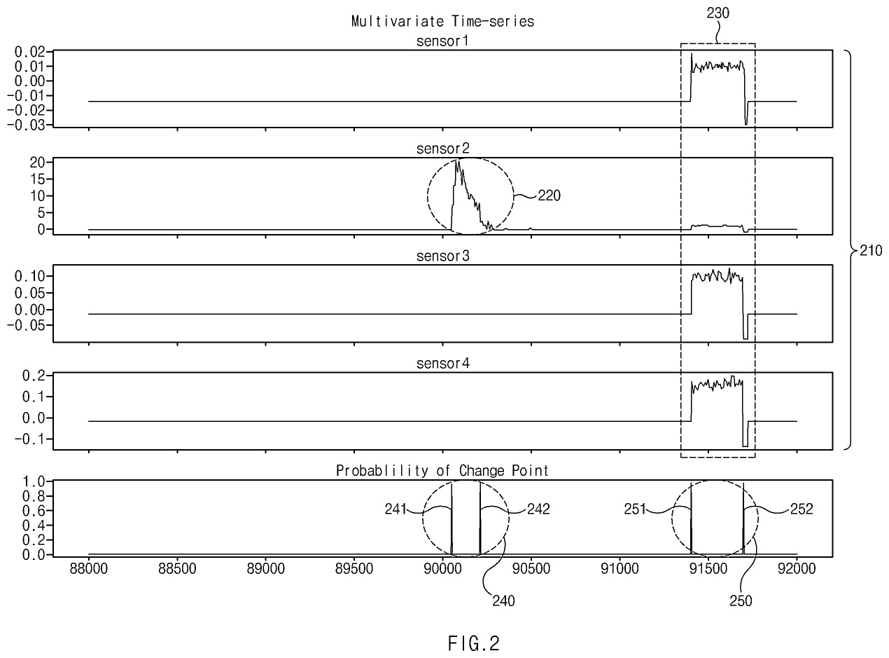

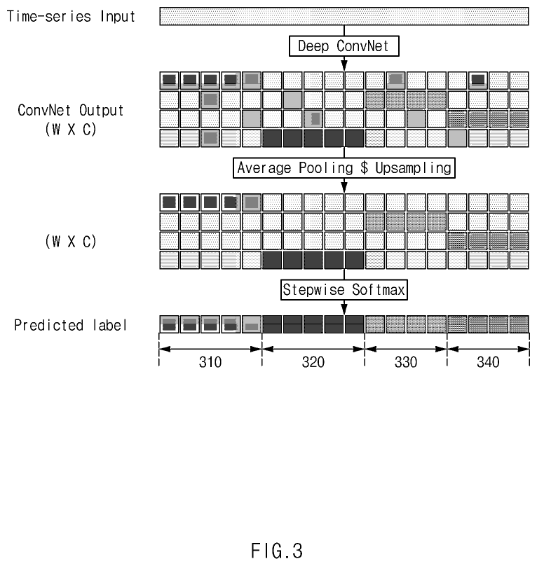

Hereinafter, an operation of the controller 40 is described in detail with reference to FIGS. 2 and 3.

FIG. 2 is a diagram illustrating a temporal feature detected from multivariate time-series data by a controller provided in a training data sampling device, according to an embodiment of the present disclosure.

In FIG. 2, ‘210’ may mean multivariate time-series data. The multivariate time-series data 210 may include time-series data measured by a first sensor, time-series data measured by a second sensor, time-series data measured by a third sensor, and time-series data measured by a fourth sensor.

‘220’ indicates a first temporal feature generated from multivariate time-series data. ‘230’ indicates a second temporal feature generated from multivariate time-series data. Here, the temporal feature refers to an abrupt change (e.g., the occurrence or termination of an event) in time-series data.

‘240’ indicates the result of the controller 40 detecting the first temporal feature 220 from multivariate time-series data based on a CPD algorithm (or model). ‘241’ indicates a change point (CP) indicating the detection result, which means the occurrence of a first event. ‘242’ indicates a CP indicating the detection result, which means the termination of the first event.

‘250’ indicates the result of the controller 40 detecting the second temporal feature 230 from multivariate time-series data based on a CPD algorithm (or model). ‘251’ indicates a CP indicating the detection result, which means the occurrence of a second event. ‘252’ indicates a CP indicating the detection result, which means the termination of the second event.

As shown in FIG. 2, the controller 40 may detect the temporal features 220 and 230 from the multivariate time-series data 210. In this case, the controller 40 may detect the temporal features 220 and 230 from the multivariate time-series data 210 based on, for example, the CPD algorithm (or model). In addition, the detection result may be expressed in the CP forms 241, 242, 251, and 252.

FIG. 3 is a diagram illustrating a process in which a controller provided in a training data sampling device performs stepwise segmentation on time-series data, according to an embodiment of the present disclosure.

In FIG. 3, ‘310’ indicates an interval occupied by a first label in time-series data. ‘320’ indicates an interval occupied by a second label in time-series data. ‘330’ indicates an interval occupied by a third label in time-series data. ‘340’ indicates an interval occupied by a fourth label in time-series data.

As shown in FIG. 3, the controller 40 may perform stepwise segmentation on time-series data based on a semantic segmentation model, may estimate a plurality of labels from the time-series data, and may determine the intervals 310, 320, 330, and 340 corresponding to each label.

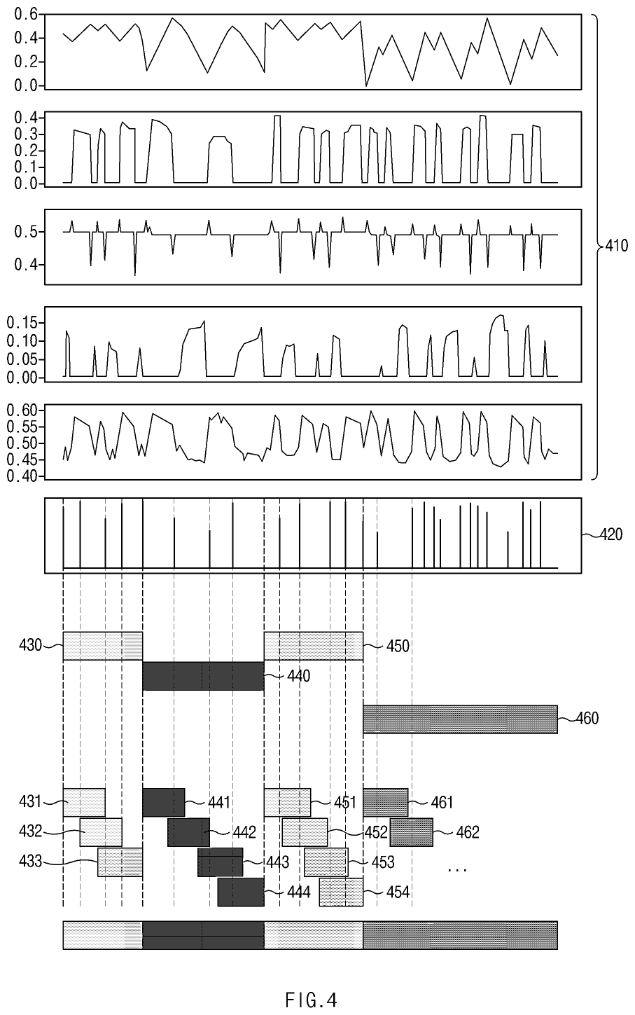

Hereinafter, a process of the controller 40 sampling training data including a temporal feature from multivariate time-series data is described with reference to FIG. 4.

FIG. 4 is a diagram illustrating a process in which a controller provided in a training data sampling device detects training data including a temporal feature from multivariate time-series data, according to an embodiment of the present disclosure.

In FIG. 4, ‘410’ indicates multivariate time-series data. ‘420’ indicates CP as a result of the controller 40 detecting the temporal feature 230 from the multivariate time-series data 410 based on a CPD algorithm (or model). ‘430’ indicates a first label interval in the multivariate time-series data 410 estimated by the controller 40. ‘440’ indicates a second label interval in the multivariate time-series data 410 estimated by the controller 40. ‘450’ indicates a third label interval in the multivariate time-series data 410 estimated by the controller 40. ‘460’ indicates a fourth label interval in the multivariate time-series data 410 estimated by the controller 40. At this time, the second label interval 440 and the fourth label interval 460 may be intervals corresponding to the same label.

The controller 40 may determine a window size (or sampling size) with the maximum separation distance between CPs adjacent to each other and may sample training data for each label interval based on the window. In this case, the controller 40 may sample training data to include at least one CP.

For example, the controller 40 may sample first training data 431, second training data 432, and third training data 433 in the first label interval 430 of multivariate time-series data. The controller 40 may also sample first training data 441, second training data 442, third training data 443, and fourth training data 444 in the second label interval 440 of multivariate time-series data. The controller 40 may also sample first training data 451, second training data 452, third training data 453, and fourth training data 454 in the third label interval 450 of multivariate time-series data. The controller 40 may also sample first training data 461 and second training data 462 in the fourth label interval 460 of multivariate time-series data.

The controller 40 may generate a train dataset by using the first training data 431, the second training data 432, and the third training data 433 in the first label interval 430, by using the first training data 441, the second training data 442, the third training data 443, and the fourth training data 444 in the second label interval 440, and by using the first training data 451, the second training data 452, the third training data 453, and the fourth training data 454 in the third label interval 450.

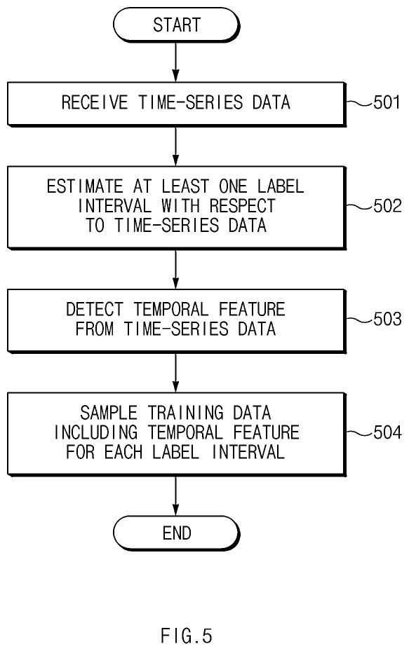

FIG. 5 is a flowchart of a training data sampling method, according to an embodiment of the present disclosure.

First of all, the input device 20 receives time-series data (501).

Afterward, the controller 40 estimates at least one label interval with respect to the time-series data (502).

Afterward, the controller 40 detects a temporal feature from the time-series data (503).

Afterward, the controller 40 samples training data including the temporal feature for each label interval (504).

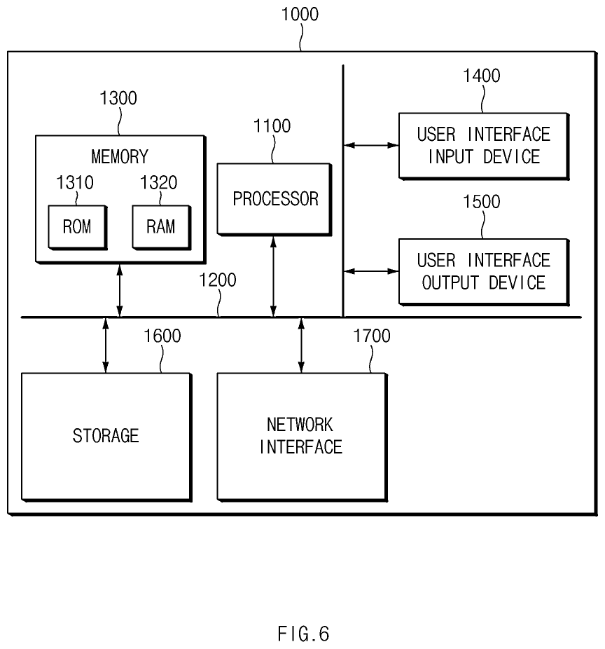

FIG. 6 is a block diagram showing a computing system for executing a training data sampling method, according to an embodiment of the present disclosure.

Referring to FIG. 6, a training data sampling method according to an embodiment of the present disclosure may be implemented through a computing system. A computing system 1000 may include at least one processor 1100, a memory 1300, a user interface input device 1400, a user interface output device 1500, storage 1600, and a network interface 1700, which are connected with each other through a system bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read only memory (ROM) 1310 and a random access memory (RAM) 1320.

Accordingly, the operations of the method or algorithm described in connection with the embodiments disclosed in the specification may be directly implemented with a hardware module, a software module, or a combination of the hardware module and the software module, which is executed by the processor 1100. The software module may reside on a storage medium (i.e., the memory 1300 and/or the storage 1600), such as a random access memory (RAM), a flash memory, a read only memory (ROM), an erasable and programmable ROM (EPROM), an electrically EPROM (EEPROM), a register, a hard disk drive, a removable disc, or a compact disc-ROM (CD-ROM). The storage medium may be coupled to the processor 1100. The processor 1100 may read out information from the storage medium and may write information in the storage medium. Alternatively, the storage medium may be integrated with the processor 1100. The processor 1100 and storage medium may be implemented with an application specific integrated circuit (ASIC). The ASIC may be provided in a user terminal. Alternatively, the processor 1100 and storage medium may be implemented with separate components in the user terminal.

The above description is merely an example of the technical idea of the present disclosure, and various modifications and variations may be made by one having ordinary skill in the art without departing from the essential characteristic of the present disclosure. Accordingly, embodiments of the present disclosure are intended not to limit but to explain the technical idea of the present disclosure, and the scope and spirit of the present disclosure is not limited by the above embodiments. The scope of protection of the present disclosure should be construed by the attached claims, and all equivalents thereof should be construed as being included within the scope of the present disclosure.

According to an embodiment of the present disclosure, it is possible to improve the reliability of training data by estimating at least one label interval for time-series data, detecting a temporal feature from the time-series data, and sampling the training data including the temporal feature for the respective label interval.

According to another embodiment of the present disclosure, it is possible to estimate at least one label from the time-series data and to determine an interval corresponding to each label, by performing stepwise segmentation on time-series data based on a semantic segmentation technique (or model).

According to another embodiment of the present disclosure, it is possible to sample training data including a temporal feature from time-series data by detecting the temporal feature indicating the occurrence or termination of an event with respect to the time-series data based on a CPD algorithm (or model).

According to another embodiment of the present disclosure, it is possible to sample training data to include at least one temporal feature by detecting a temporal feature indicating the occurrence or termination of an event from time-series data based on a CPD algorithm (or model) and determining a window size (or sampling size) based on a maximum separation distance between CPs adjacent to each other among CPs corresponding to the temporal feature.

Hereinabove, although the present disclosure has been described with reference to embodiments and the accompanying drawings, the present disclosure is not limited thereto. The present disclosure may be variously modified and altered by those having ordinary skill in the art to which the present disclosure pertains without departing from the spirit and scope of the present disclosure claimed in the following claims.

What is claimed is:

1. A training data sampling device comprising:
an input device configured to receive time-series data; and
a controller configured to:
estimate at least one label interval from the time-series data;
detect a temporal feature from the time-series data; and
sample training data including the temporal feature by the label interval.

2. The training data sampling device of claim 1, wherein the controller is configured to determine the at least one label interval in the time-series data by performing stepwise segmentation on the time-series data.

3. The training data sampling device of claim 1, wherein the controller is configured to:
detect a temporal feature indicating an occurrence or termination of an event from the time-series data, and
sample training data including the temporal feature from the time-series data.

4. The training data sampling device of claim 3, wherein the controller is configured to detect the temporal feature based on a change point detection (CPD) algorithm.

5. The training data sampling device of claim 3, wherein the controller is configured to determine a sampling size based on a maximum separation distance between change points (CPs), which are adjacent to each other, from among CPs corresponding to the temporal feature.

6. The training data sampling device of claim 1, wherein the controller is configured to:
sample first training data, second training data, and third training data in a first label interval of the time-series data,
sample first training data, second training data, third training data, and fourth training data in a second label interval of the time-series data,
sample first training data, second training data, third training data, and fourth training data in a third label interval of the time-series data, and
sample first training data and second training data in a fourth label interval of the time-series data.

7. The training data sampling device of claim 6, wherein the controller is configured to generate a train dataset:
by using the first training data, the second training data, and the third training data in the first label interval;
by using the first training data, the second training data, the third training data, and the fourth training data in the second label interval;
by using the first training data, the second training data, the third training data, and the fourth training data in the third label interval; and
by using the first training data and the second training data in the fourth label interval.

8. The training data sampling device of claim 1, wherein the time-series data is streaming time-series data.

9. The training data sampling device of claim 1, wherein the time-series data is multivariate time-series data.

10. A training data sampling method, the method comprising:
receiving, by an input device, time-series data;
estimating, by a controller, at least one label interval from the time-series data;
detecting, by the controller, a temporal feature from the time-series data; and
sampling, by the controller, training data including the temporal feature by the label interval.

11. The method of claim 10, wherein estimating the at least one label interval from the time-series data includes:
determining, by the controller, the at least one label interval in the time-series data by performing stepwise segmentation on the time-series data.

12. The method of claim 10, wherein detecting the temporal feature from the time-series data includes:
detecting, by the controller, a temporal feature indicating an occurrence or termination of an event from the time-series data.

13. The method of claim 10, wherein detecting the temporal feature from the time-series data includes:
detecting, by the controller, the temporal feature from the time-series data based on a change point detection (CPD) algorithm.

14. The method of claim 10, wherein sampling the training data including the temporal feature includes:
determining, by the controller, a sampling size based on a maximum separation distance between change points (CPs), which are adjacent to each other, from among CPs corresponding to the temporal feature.

15. The method of claim 10, wherein sampling the training data including the temporal feature includes:
sampling, by the controller, first training data, second training data, and third training data in a first label interval of the time-series data;
sampling, by the controller, first training data, second training data, third training data, and fourth training data in a second label interval of the time-series data;
sampling, by the controller, first training data, second training data, third training data, and fourth training data in a third label interval of the time-series data; and
sampling, by the controller, first training data and second training data in a fourth label interval of the time-series data.

16. The method of claim 15, wherein sampling the training data including the temporal feature further includes:
generating, by the controller, a train dataset:
by using the first training data, the second training data, and the third training data in the first label interval;
by using the first training data, the second training data, the third training data, and the fourth training data in the second label interval;
by using the first training data, the second training data, the third training data, and the fourth training data in the third label interval; and
by using the first training data and the second training data in the fourth label interval.

17. The method of claim 10, wherein the time-series data is streaming time-series data.

18. The method of claim 10, wherein the time-series data is multivariate time-series data.
